(19) United States
(12) Patent Application Publication
(10) Pub. No.: US 2008/0253561 A1
(43) Pub. Date: Oct. 16, 2008

(54) Common-Key Block Encryption Device Common-Key Block Encryption Method, and Common-Key Block Encryption Program

(75) Inventor: Kazuhiko Minematsu, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/721,372

(22) PCT Filed: Dec. 12, 2005
(86) PCT No.: PCT/JP05/22773

§ 371 Date: Jun. 11, 2007

(30) Foreign Application Priority Data
Dec. 17, 2004 (JP) 2004-366363
Jul. 8, 2005 (JP) 2005-200188

(51) Int. Cl. H04L 9/06

(52) U.S. Cl. 380/29

(57) ABSTRACT

Disclosed is a common-key block encryption device including first Feistel-type hash means that divides a plain text into a PA block and a PB block and adds the PB block, which is compressed by a hash function, and the PA block to generate a unit block intermediate text; unit block encryption means that encrypts the unit block intermediate text to generate a unit block intermediate cipher text; pseudorandom number generation means that generates an intermediate random number based on the unit block intermediate cipher text; addition means that adds the intermediate random number and the PB block and outputs an addition result; second Feistel-type hash means that outputs a result that is a combination of a second addition result, generated based on the addition result compressed by a hash function and the unit block intermediate cipher text, and the addition result; and cipher text output means that outputs the output result as a cipher text.

### TECHNICAL FIELD

The present invention relates to a common-key block encryption device, a common-key block encryption method, and a common-key block encryption program, and more particular, to a common-key block encryption device, a common-key block encryption method, and a common-key block encryption program that employ combination of highly secure encryption processing and high-speed encryption processing to perform block-encryption of large blocks of data.

### BACKGROUND ART

Recently, many approaches are known for constructing a new encryption using encryption processing, such as block encryption or a hash function, as encryption parts.

For example, in the field of file encryption, a study is being conducted to construct a larger-block-size (512 bits and so on) block encryption, which corresponds to a sector size, using the standard-block-size (128 bits and so on) block encryption to make it easy to process encrypted data in units of sectors.

Usually, the combination of those encryption parts has been required so that the security against a Chosen Plain text Attack (CPA) of those encryption parts will ensure the full security of a newly configured encryption composed of the encryption parts. The full security of a newly configured encryption means security against the chosen plain text attack or security against the chosen plain-text/cipher-text attack when the newly configured encryption is block encryption, and means security against the chosen plain text attack (in a model in which the attacker can select an initial vector) when the newly configured encryption is stream encryption.

Note that, if a method uses only the encryption parts that are secure against the chosen plain text attack, the throughput (processing amount per unit time) of a newly configured encryption is not higher than that of the encryption parts.

On the other hand, there is a method that not only uses the encryption parts that are secure against the chosen plain text attack but also combines the encryption parts that are secure against the chosen plain text attack and the encryption parts that are secure against a Known Plain text Attack (KPA) (for example, see Patent Document 1 and Non-Patent Document 1).

The technology disclosed in Patent Document 1 described above and Non-Patent Document 1 described above expands the output of block encryption using a hash function or stream encryption to configure stream encryption. Patent Document 1 described above discloses that using both block encryption that is secure against the chosen plain text attack and a hash function and a stream encryption that are secure against the known plain text attack ensures the security of the newly configured stream encryption.

The known plain text attack belongs to a class that is weaker than the chosen plain text attack. The encryption parts, which are secure against the known plain text attack, has less requirements for security and, therefore, are expected to operate faster than the encryption parts that are secure against the chosen plain text attack. In addition, in the method described in Patent Document 1 given above, using both block encryption that is secure against the chosen plain text attack and a hash function and a stream encryption that are secure against the known plain text attack allows the throughput of a newly configured encryption to be made almost equal to the throughput of the encryption parts that are secure against the known plain text attack.

Let P1 be an encryption part that is secure against the chosen plain text attack, and let P2 be an encryption part that is secure against the known plain text attack.

Let K1 be the key of the encryption part P1 that is secure against the chosen plain text attack, and let K2_1, K2_2, . . . , K2_t be the mutually independent t keys (t is a positive integer) of the encryption part P2 that is secure against the known plain text attack.

Let Pi[k](m) represent the cipher text of m when a plain text m is encrypted using the key K of encryption Pi (i is 1 or 2).

Under this condition, one block of key stream G is expressed by the following (Expression 1) in the stream encryption according to the method disclosed in Patent Document 1 described above.

G=(P2[K2_{—}1](Y),P2[K2_{—}2](Y), . . . , P2[K2_{—}t](Y)) (Expression 1)

where, Y represents the output P1[K1](c) of P1 when the initial input is c and the key is K1.

Instead of (Expression 1) given above, the method disclosed in Non-Patent Document 2 may also be applied. This is expressed by (Expression 1′) given below.

G_{—}{1,1}◯(G_{—}[2,2]◯(G_{—}[3,4] . . . G_[d,2̂(d−1)] . . . )(Y) (Expression 1′)

d is the minimum positive integer equal to or larger than log_{—}[2](t)−1, and G_[i] is a one-block input/two-block output for i=1, 2, . . . , d using two keys of P2. The processing G_[i](X)=(P2[K2_{—}2i−1](X),P2[K2_{—}2i](X)) is performed.

G_[i,2̂(i−1)] is a 2̂(i−1) block input/2̂(i) block output, G_[i] is applied to all input blocks, and the results of the outputs are concatenated and output. The whole output is produced by concatenating the output of each G_[i,2̂(i−1)]. FIG. 8 shows a case in which four keys of P2 are used. The symbol ◯ is the operator indicating the composite of the functions and, for the two functions F and G, F◯G represents the composite function F◯G(X)=G(F(X)). Here, the mode, in which Y in (Expression 1′) represents P1[K1](c) as it does in (Expression 1), is called a Pseudorandom Tree Mode (abbreviated PRT mode).

In the description below, t is called an expansion rate because the output Y of P1 is multiplied by t. There are many methods for generating the initial input c; for example, a variable whose initial value is 1 and is counted up each time one block of key stream is generated is defined as c.

Although the method disclosed in Patent Document 1 given above relates to encryption processing that outputs t blocks for one block of input, the similar processing may also be performed using only P1. To do so, the modified counter mode disclosed in Non-Patent Document 3 or the modified OFB (Output Feed Back) mode may be used. The modified counter mode using P1 is shown in (Expression 2), and the modified OFB mode using P1 is shown in (Expression 3).

(P1(P1(x)+c_{—}1),P1(P1(x)+c_{—}2), . . . , P1(P1(x)+c_t))) is output for the input x, where c_{—}1, . . . , c_t are t constants different each other. (Expression 2)

(P1(P1(x)),P1(P1(x)+y_{—}1), . . . , P1(P1(x)+y_t−1) is output for the input x, where y_{—}1=P1(P1(x)),y_{—}2=P1(P1(x)+y_{—}1, . . . , y_{—}t−1=P1(P1(x)+y_{—}t−2) is satisfied. (Expression 3)

The modified counter mode or the modified OFB mode uses the encryption parts composed only of P1 but does not require additional encryption parts P2, thus making the configuration simple. However, the throughput of the modified counter mode or the modified OFB mode is never higher than that of the encryption parts of P1.

Another technical document filed before the present invention proposes a block encryption method and a composite method (for example, see Patent Document 2). According to the method, the input data encryption stage is composed of at least two stages and, in each encryption stage, the cipher block chaining mode is used for encryption on a basis of a block of a specified number of bytes. In addition, a fixed initialization vector, not dependent on the input data, is used in the first encryption stage and one-block encryption result in the preceding encryption means is used as the initialization vector in the subsequent encryption stages to make it difficult to estimate the original data when a large amount of data, which is blocked, is encrypt ed.

Another method is that a plain text M is split into r(r is an integer equal to or larger than 2) split plain texts, n (n<r) split plain texts out of r split plain texts are encrypted into n cipher texts, the remaining (r−n) split plain texts and the n cipher texts are output as an output cipher text to configure a high-speed, simple encryption system (for example, see Patent Document 3).

A technology related to the hash function is also disclosed (for example, see Non-Patent Document 4).

A technology related to AES (Advanced Encryption Standard)-based block encryption that is secure against the chosen plain text attack/cipher text attack is also disclosed (for example, see Non-Patent Document 5).

A technology related to stream encryption SEAL is also disclosed (for example, see Non-Patent Document 6).

Patent Document 1: U.S. Pat. No. 6,104,811 Specification

Patent Document 2: Japanese Patent Kokai Publication No. JP-P2002-108205A

Patent Document 3: Japanese Patent Kokai Publication No. JP-P2002-175008A

Non-Patent Document 1: W. Aiello, R. Rajagopalan and V. Venkatesan, High-Speed Pseudorandom Number Generation With Small Memory, Fast Software Encryption, 6th International Workshop, FSE'99, Lecture Notes in Computer Science; Vol. 1636, March 1999

Non-Patent Document 2: Ivan Damgard and Jusper Buus Nielsen, Expanding Pseudorandom Functions; or: From Known-Plaintext Security to Chosen-Plaintext Security, Advances in Cryptology-CRYPTO'02, LNCS 2442, 2002.

Non-Patent Document 3: H. Gilbert, The Security of “One-Block-to-Many” Modes of Operation, Fast Software Encryption, 10th International Workshop, FSE'03, Lecture Notes in Computer Science; Vol. 2887, February 2003.

Non-Patent Document 4: S. Halevi and H. Krawczyk, MMH: Software Message Authentication in the Gbit/second rates, Fast Software Encryption, 4th International Workshop, FSE '97, Lecture Notes in Computer Science; Vol. 1267, February 1997.

Non-Patent Document 5: J. Daemen, V. Rijmen, “AES Proposal: Rijndael”, AES submission, 1998.

Non-Patent Document 6: P. Rogaway and D. Coppersmith, A Software-Optimized Encryption Algorithm, Fast Software Encryption, 1st International Workshop, FSE'93, Lecture Notes in Computer Science; Vol. 809, February 1993.

### THE SUMMARY OF THE DISCLOSURE

The following analysis is given by the present invention.

Although Patent Document 1 described above discloses that the output of block encryption is expanded by a hash function or stream encryption to configure stream encryption, no consideration is made for the configuration method of secure block encryption implemented by combining encryption parts that are secure against the chosen plain text attack and encryption parts that are secure against the known plain text attack.

The method described in Patent Document 1 given above has a problem of a heavy implementation load when the expansion rate is high. The reason it that, according to the method described in Patent Document 1 given above, the key linearly becomes longer as the expansion rate becomes higher. In such a case, appropriate key scheduling is employed to expand a short private key before use; however, this processing means an increase in the calculation amount of pre-processing for key scheduling. This method also increases the amount of memory required for encryption.

Accordingly, it is an exemplary object of the present invention to provide a common-key block encryption device, a common-key block encryption method, and a common-key block encryption program that combine encryption parts that are secure against the chosen plain text attack with encryption parts that are secure against the known plain text attack or combines encryption parts that are secure against the chosen plain text/cipher text attack and encryption parts that are secure against the known plain text attack to provide secure block encryption.

The above and other objects are attained by the present invention, in which there are provided the following features.

A common-key block encryption device according to one aspect of the present invention is characterized in that said device comprises first Feistel-type hash means that divides a plain text to be encrypted into a first block and a second block, compresses the divided first block by a hash function, adds the compressed first block and the second block to generate a unit block intermediate text, and outputs the generated unit block intermediate text and the first block; unit block encryption means that encrypts the unit block intermediate text to generate a unit block intermediate cipher text; pseudorandom number generation means that generates an intermediate random number based on the unit block intermediate cipher text; addition means that adds the intermediate random number and the first block and outputs an addition result; second Feistel-type hash means that compresses the addition result by a hash function, adds the compressed addition result and the unit block intermediate cipher text to generate a second addition result, and outputs an output result that is a combination of the generated second addition result and the addition result; and cipher text output means that outputs the output result as a cipher text.

A common-key block encryption device according to another aspect of the present invention comprises first Feistel-type hash means that divides a plain text to be encrypted into a first block and a second block, compresses the divided first block by a hash function, adds the compressed first block and the second block to generate a unit block intermediate text, and outputs the generated unit block intermediate text and the first block; unit block encryption means that encrypts the unit block intermediate text to generate a unit block intermediate cipher text; pseudorandom number generation means that generates an intermediate random number based on the unit block intermediate cipher text; addition means that adds the intermediate random number and the first block and outputs an addition result; and cipher text output means that concatenates the addition result with the unit block intermediate cipher text and outputs the concatenated result as a cipher text.

In the common-key block encryption device according to the present invention, the unit block encryption means encrypts the unit block intermediate text using block encryption to generate the unit block intermediate cipher text and the pseudorandom number generation means generates the intermediate random number by concatenating multiple-block cipher texts, the multiple-block cipher texts being obtained by entering the unit block intermediate cipher text into an ordered tree mode implemented by the block encryption and a simplified block encryption obtained by simplifying the block encrypt ion.

In the common-key block encryption device according to the present invention, the unit block encryption means encrypts the unit block intermediate text using block encryption to generate the unit block intermediate cipher text and the pseudorandom number generation means generates the intermediate random number by concatenating multiple-block cipher texts, the multiple-block cipher texts being obtained by entering the unit block intermediate cipher text into a PRT mode that is implemented by the block encryption and simplified block encryption created by simplifying the block encryption, into an ERT mode, or into a combination mode of an ordered tree mode, the PRT mode, and the ERT mode.

In the common-key block encryption device according to the present invention, the unit block encryption means encrypts the unit block intermediate text using block encryption to generate the unit block intermediate cipher text and the pseudorandom number generation means generates the intermediate random number by concatenating multiple-block cipher texts, the multiple-block cipher texts being obtained by entering the unit block intermediate cipher text into a modified counter mode that uses the block encryption.

In the common-key block encryption device according to the present invention, the unit block encryption means encrypts the unit block intermediate text using block encryption to generate the unit block intermediate cipher text and the pseudorandom number generation means generates the intermediate random number by concatenating multiple-block cipher texts, the multiple-block cipher texts being obtained by entering the unit block intermediate cipher text into a modified OFB mode that uses the block encryption.

In the common-key block encryption device according to the present invention is characterized in that the unit block encryption means encrypts the unit block intermediate text using block encryption to generate the unit block intermediate cipher text and the pseudorandom number generation means generates the intermediate random number by concatenating a plurality of cipher texts, the plurality of cipher texts being obtained by entering the unit block intermediate cipher text into a mode in which first encryption processing of an ordered tree mode, implemented by the block encryption and a simplified block encryption created by simplifying the block encryption, is omitted.

In the common-key block encryption device according to the present invention, the unit block encryption means encrypts the unit block intermediate text using block encryption to generate the unit block intermediate cipher text and the pseudorandom number generation means generates the intermediate random number by concatenating a plurality of cipher texts, the plurality of cipher texts being obtained by entering the unit block intermediate cipher text into a mode in which first encryption processing is omitted from a PRT mode that is implemented by the block encryption and simplified block encryption created by simplifying the block encryption, from an ERT mode, or from a combination mode of an ordered tree mode, the PRT mode, and the ERT mode.

In the common-key block encryption device according to the present invention, the unit block encryption means encrypts the unit block intermediate text using block encryption to generate the unit block intermediate cipher text and the pseudorandom number generation means generates the intermediate random number by concatenating multiple-block cipher texts obtained by entering the unit block intermediate cipher text into a mode in which first encryption processing of a modified counter mode that uses the block encryption is omitted.

In the common-key block encryption device according to the present invention, the unit block encryption means encrypts the unit block intermediate text using block encryption to generate the unit block intermediate cipher text and the pseudorandom number generation means generates the intermediate random number by concatenating multiple-block cipher texts obtained by entering the unit block intermediate cipher text into a mode in which first encryption processing of a modified OFB mode that uses the block encryption is omitted.

In the common-key block encryption device according to the present invention, the unit block encryption means encrypts the unit block intermediate text using block encryption to generate the unit block intermediate cipher text and the pseudorandom number generation means generates the intermediate random number by entering, as an initial vector, the unit block intermediate cipher text into stream encryption that accepts the initial vector as an additional input.

A common-key block encryption method according to one aspect of the present invention is a common-key block encryption method performed by an information processing device comprising a first Feistel-type hash step that divides a plain text to be encrypted into a first block and a second block, compresses the divided first block by a hash function, adds the compressed first block and the second block to generate a unit block intermediate text, and outputs the generated unit block intermediate text and the first block; a unit block encryption step that encrypts the unit block intermediate text to generate a unit block intermediate cipher text; a pseudorandom number generation step that generates an intermediate random number based on the unit block intermediate cipher text; an addition step that adds the intermediate random number and the first block and outputs an addition result; a second Feistel-type hash step that compresses the addition result by a hash function, adds the compressed addition result and the unit block intermediate cipher text to generate a second addition result, and outputs the generated second addition result and the addition result; and a cipher text output step that outputs a cipher text based on the second addition result and the addition result.

A common-key block encryption method according to another aspect of the present invention is a common-key block encryption method performed by an information processing device comprising first Feistel-type hash step that divides a plain text to be encrypted into a first block and a second block, compresses the divided first block by a hash function, adds the compressed first block and the second block to generate a unit block intermediate text, and outputs the generated unit block intermediate text and the first block; unit block encryption step that encrypts the unit block intermediate text to generate a unit block intermediate cipher text; pseudorandom number generation step that generates an intermediate random number based on the unit block intermediate cipher text; addition step that adds the intermediate random number and the first block and outputs an addition result; and cipher text output step that concatenates the addition result with the unit block intermediate cipher text and outputs the concatenated result as a cipher text.

In the common-key block encryption method according to the present invention, the unit block encryption step encrypts the unit block intermediate text using block encryption to generate the unit block intermediate cipher text and the pseudorandom number generation step generates the intermediate random number by concatenating multiple-block cipher texts, the multiple-block cipher texts being obtained by entering the unit block intermediate cipher text into an ordered tree mode implemented by the block encryption and a simplified block encryption obtained by simplifying the block encrypt ion.

In the common-key block encryption method according to the present invention, the unit block encryption step encrypts the unit block intermediate text using block encryption to generate the unit block intermediate cipher text and the pseudorandom number generation step generates the intermediate random number by concatenating multiple-block cipher texts, the multiple-block cipher texts being obtained by entering the unit block intermediate cipher text into a PRT mode that is implemented by the block encryption and simplified block encryption created by simplifying the block encryption, into an ERT mode, or into a combination mode of an ordered tree mode, the PRT mode, and the ERT mode.

In the common-key block encryption method according to the present invention, the unit block encryption step encrypts the unit block intermediate text using block encryption to generate the unit block intermediate cipher text and the pseudorandom number generation step generates the intermediate random number by concatenating multiple-block cipher texts, the multiple-block cipher texts being obtained by entering the unit block intermediate cipher text into a modified counter mode that uses the block encryption.

In the common-key block encryption method according to the present invention, the unit block encryption step encrypts the unit block intermediate text using block encryption to generate the unit block intermediate cipher text and the pseudorandom number generation step generates the intermediate random number by concatenating multiple-block cipher texts, the multiple-block cipher texts being obtained by entering the unit block intermediate cipher text into a modified OFB mode that uses the block encryption.

In the common-key block encryption method according to the present invention, the unit block encryption step encrypts the unit block intermediate text using block encryption to generate the unit block intermediate cipher text and the pseudorandom number generation step generates the intermediate random number by concatenating a plurality of cipher texts, the plurality of cipher texts being obtained by entering the unit block intermediate cipher text into a mode in which first encryption processing of an ordered tree mode, implemented by the block encryption and a simplified block encryption created by simplifying the block encryption, is omitted.

In the common-key block encryption method according to the present invention, the unit block encryption step encrypts the unit block intermediate text using block encryption to generate the unit block intermediate cipher text and the pseudorandom number generation step generates the intermediate random number by concatenating a plurality of cipher texts, the plurality of cipher texts being obtained by entering the unit block intermediate cipher text into a mode in which first encryption processing is omitted from a PRT mode that is implemented by the block encryption and simplified block encryption created by simplifying the block encryption, from an ERT mode, or from a combination mode of an ordered tree mode, the PRT mode, and the ERT mode.

In the common-key block encryption method according to the present invention, the unit block encryption step encrypts the unit block intermediate text using block encryption to generate the unit block intermediate cipher text and the pseudorandom number generation step generates the intermediate random number by concatenating multiple-block cipher texts obtained by entering the unit block intermediate cipher text into a mode in which first encryption processing of a modified counter mode that uses the block encryption is omitted.

In the common-key block encryption method according to the present invention, the unit block encryption step encrypts the unit block intermediate text using block encryption to generate the unit block intermediate cipher text and the pseudorandom number generation step generates the intermediate random number by concatenating multiple-block cipher texts obtained by entering the unit block intermediate cipher text into a mode in which first encryption processing of a modified OFB mode that uses the block encryption is omitted.

In the common-key block encryption method according to the present invention, the unit block encryption step encrypts the unit block intermediate text using block encryption to generate the unit block intermediate cipher text and the pseudorandom number generation step generates the intermediate random number by entering, as an initial vector, the unit block intermediate cipher text into stream encryption that accepts the initial vector as an additional input.

A common-key block encryption program according to one aspect of the present invention is a common-key block encryption programcausing an information processing device to execute a first Feistel-type hash process that divides a plain text to be encrypted into a first block and a second block, compresses the divided first block by a hash function, adds the compressed first block and the second block to generate a unit block intermediate text, and outputs the generated unit block intermediate text and the first block; a unit block encryption process that encrypts the unit block intermediate text to generate a unit block intermediate cipher text; a pseudorandom number generation process that generates an intermediate random number based on the unit block intermediate cipher text; an addition process that adds the intermediate random number and the first block and outputs an addition result; a second Feistel-type hash process that compresses the addition result by a hash function, adds the compressed addition result and the unit block intermediate cipher text to generate a second addition result, and outputs the generated second addition result and the addition result; and a cipher text output process that outputs a cipher text based on the second addition result and the addition result.

A common-key block encryption program according to another aspect of the present invention is a common-key block encryption program causing an information processing device to execute a first Feistel-type hash process that divides a plain text to be encrypted into a first block and a second block, compresses the divided first block by a hash function, adds the compressed first block and the second block to generate a unit block intermediate text, and outputs the generated unit block intermediate text and the first block; a unit block encryption process that encrypts the unit block intermediate text to generate a unit block intermediate cipher text; a pseudorandom number generation process that generates an intermediate random number based on the unit block intermediate cipher text; an addition process that adds the intermediate random number and the first block and outputs an addition result; and a cipher text output process that concatenates the addition result with the unit block intermediate cipher text and outputs the concatenated result as a cipher text.

In the common-key block encryption program according to the present invention, the unit block encryption process encrypts the unit block intermediate text using block encryption to generate the unit block intermediate cipher text and the pseudorandom number generation process generates the intermediate random number by concatenating multiple-block cipher texts, the multiple-block cipher texts being obtained by entering the unit block intermediate cipher text into an ordered tree mode implemented by the block encryption and a simplified block encryption obtained by simplifying the block encrypt ion.

In the common-key block encryption program according to the present invention, the unit block encryption process encrypts the unit block intermediate text using block encryption to generate the unit block intermediate cipher text and the pseudorandom number generation process generates the intermediate random number by concatenating multiple-block cipher texts, the multiple-block cipher texts being obtained by entering the unit block intermediate cipher text into a PRT mode that is implemented by the block encryption and simplified block encryption created by simplifying the block encryption, into an ERT mode, into an ordered tree mode, or into a combination mode of the ordered tree mode, the PRT mode, and the ERT mode.

In the common-key block encryption program according to the present invention, the unit block encryption process encrypts the unit block intermediate text using block encryption to generate the unit block intermediate cipher text and the pseudorandom number generation process generates the intermediate random number by concatenating multiple-block cipher texts, the multiple-block cipher texts being obtained by entering the unit block intermediate cipher text into a modified counter mode that uses the block encryption.

In the common-key block encryption program according to the present invention, the unit block encryption process encrypts the unit block intermediate text using block encryption to generate the unit block intermediate cipher text and the pseudorandom number generation process generates the intermediate random number by concatenating multiple-block cipher texts, the multiple-block cipher texts being obtained by entering the unit block intermediate cipher text into a modified OFB mode that uses the block encryption.

In the common-key block encryption program according to the present invention, the unit block encryption process encrypts the unit block intermediate text using block encryption to generate the unit block intermediate cipher text and the pseudorandom number generation process generates the intermediate random number by concatenating a plurality of cipher texts, the plurality of cipher texts being obtained by entering the unit block intermediate cipher text into a mode in which first encryption processing of an ordered tree mode, implemented by the block encryption and a simplified block encryption created by simplifying the block encryption, is omitted.

In the common-key block encryption program according to the present invention, the unit block encryption process encrypts the unit block intermediate text using block encryption to generate the unit block intermediate cipher text and the pseudorandom number generation process generates the intermediate random number by concatenating a plurality of cipher texts, the plurality of cipher texts being obtained by entering the unit block intermediate cipher text into a mode in which first encryption processing is omitted from a PRT mode that is implemented by the block encryption and simplified block encryption created by simplifying the block encryption, from an ERT mode, or from a combination mode of an ordered tree mode, the PRT mode, and the ERT mode.

In the common-key block encryption program according to the present invention, the unit block encryption process encrypts the unit block intermediate text using block encryption to generate the unit block intermediate cipher text and the pseudorandom number generation process generates the intermediate random number by concatenating multiple-block cipher texts obtained by entering the unit block intermediate cipher text into a mode in which first encryption processing of a modified counter mode that uses the block encryption is omitted.

In the common-key block encryption program according to the present invention, the unit block encryption process encrypts the unit block intermediate text using block encryption to generate the unit block intermediate cipher text and the pseudorandom number generation process generates the intermediate random number by concatenating multiple-block cipher texts obtained by entering the unit block intermediate cipher text into a mode in which first encryption processing of a modified OFB mode that uses the block encryption is omitted.

In the common-key block encryption program according to the present invention, the unit block encryption process encrypts the unit block intermediate text using block encryption to generate the unit block intermediate cipher text and the pseudorandom number generation process generates the intermediate random number by entering, as an initial vector, the unit block intermediate cipher text into stream encryption that accepts the initial vector as an additional input.

The meritorious effects of the present invention are summarized as follows.

A common-key block encryption device, a common-key block encryption method, and a common-key block encryption program in accordance with the present invention divide a plain text to be encrypted into a first block and a second block, compress the divided first block by a hash function, add up the compressed first block and the second block to generate a unit block intermediate text, and output the generated unit block intermediate text and the first block. The device, method, and program encrypt the unit block intermediate text to generate a unit block intermediate cipher text. After that, the device, method, and program generate an intermediate random number based on the unit block intermediate cipher text, add up the generated intermediate random number and the first block, and output an addition result. After that, the device, method, and program compress the addition result by a hash function, add up the compressed addition result and the unit block intermediate cipher text to generate a second addition result, and output the generated second addition result and the addition result. After that, the device, method, and program output the output result as a cipher text. This makes it possible to be secure against the chosen plain text/cipher text attack.

Alternatively, a common-key block encryption device, a common-key block encryption method, and a common-key block encryption program divide a plain text to be encrypted into a first block and a second block, compress the divided first block by a hash function, add up the compressed first block and the second block to generate a unit block intermediate text, and output the generated unit block intermediate text and the first block. After that, the device, method, and program encrypt the unit block intermediate text to generate a unit block intermediate cipher text. After that, the device, method, and program generate an intermediate random number based on the unit block intermediate cipher text, add up the generated intermediate random number and the first block, and output an addition result. After that, the device, method, and program concatenate the addition result with the unit block intermediate cipher text and output a concatenated result as a cipher text. This makes it possible to be secure against the chosen plain text attack.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing the configuration of a common-key block encryption device in a first example.

FIG. 2 is a flowchart showing the processing operation of the common-key block encryption device in the first example.

FIG. 3 is a block diagram showing the configuration of a common-key block encryption device in a second example.

FIG. 4 is a flowchart showing the processing operation of the common-key block encryption device in the second example.

FIG. 5 is a flowchart showing the processing operation in the ordered tree mode of pseudorandom number generation means (104) of a common-key block encryption device in a third example.

FIG. 6 is a block diagram showing the configuration of the pseudorandom number generation means (104) when t=3 and r=3.

FIG. 7 is a block diagram showing the configuration of the ERT mode when four keys of P2 are used.

FIG. 8 is a block diagram showing the configuration of the PRT mode when four keys of P2 are used.

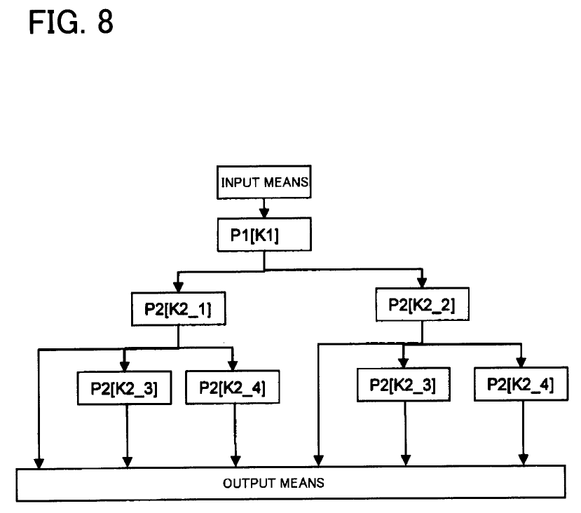

### EXPLANATIONS OF SYMBOLS

101,201 Plain text input means
102,202 First Feistel-type hash means
103,203 Unit block encryption means
104,204 Pseudorandom number generation means
105,205 Addition means
106 Second Feistel-type hash means
107,206 Cipher text output means

### EXAMPLES OF THE INVENTION

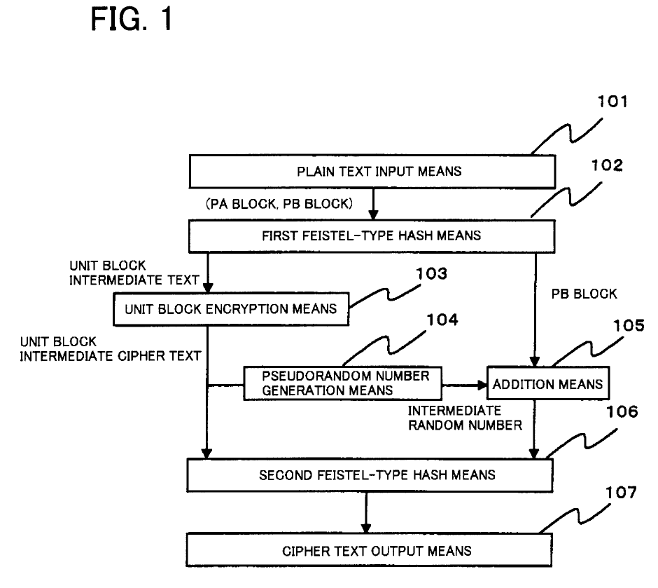

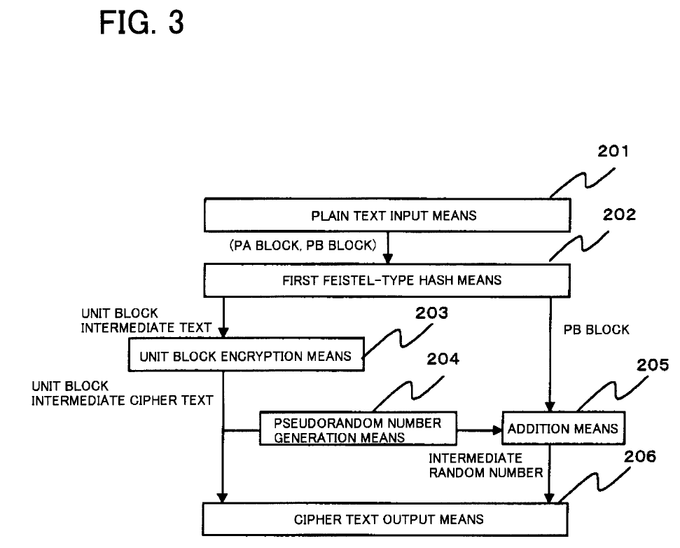

First, a common-key block encryption device in this example will be described with reference to FIG. 1 and FIG. 3.

As shown in FIG. 1, a first common-key block encryption device in this example comprises plain text input means (101) that receives a plain text to be encrypted; first Feistel-type hash means (102) that divides the plain text into a PA block and a PB block, compresses the divided PB block by a hash function, adds the compressed PB block and the PA block to generate a unit block intermediate text, and outputs the generated unit block intermediate text and the PB block; unit block encryption means (103) that encrypts the unit block intermediate text to generate a unit block intermediate cipher text; pseudorandom number generation means (104) that generates an intermediate random number based on the unit block intermediate cipher text; addition means (105) that adds the intermediate random number and the PB block and outputs an addition result; second Feistel-type hash means (106) that compresses the addition result by a hash function, adds the compressed addition result and the unit block intermediate cipher text to generate a second addition result, and outputs an output result that is a combination of the generated second addition result and the addition result; and cipher text output means (107) that outputs the output result as a cipher text. This configuration makes it possible to combine the encryption parts that are secure against the chosen plain text/cipher text attack with the encryption parts that are secure against the known plain text attack to provide secure block encryption. As shown in FIG. 3, a second common-key block encryption device comprises plain text input means (201) that receives a plain text to be encrypted; first Feistel-type hash means (202) that divides the plain text into a PA block and a PB block, compresses the divided PB block by a hash function, adds the compressed PB block and the PA block to generate a unit block intermediate text, and outputs the generated unit block intermediate text and the PB block; unit block encryption means (203) that encrypts the unit block intermediate text to generate a unit block intermediate cipher text; pseudorandom number generation means (204) that generates an intermediate random number based on the unit block intermediate cipher text; addition means (205) that adds the intermediate random number and the PB block and outputs an addition result; and cipher text output means (206) that concatenates the addition result with the unit block intermediate cipher text and outputs the concatenated result as a cipher text. This configuration makes it possible to combine the encryption parts that are secure against the chosen plain text attack with the encryption parts that are secure against the known plain text attack to provide secure block encryption. The security required for block encryption is the security against the chosen plain text attack or the security against the chosen plain text/cipher text attack that combines the chosen plain text attack with the chosen cipher text attack. Which is required depends on the purpose of the use. If the unit block encryption means (103) is secure against the chosen plain text/cipher text attack and the pseudorandom number generation means (104) is secure against the chosen plain text attack, the first common-key block encryption device can be secure against the chosen plain text/cipher text attack. The second common-key block encryption device can be secure against the chosen plain text attack. The following describes the common-key block encryption device in this example more in detail with reference to the attached drawings.

### First Example

First, with reference to FIG. 1, the configuration of a common-key block encryption device in a first example will be described. FIG. 1 is a block diagram showing the configuration of the common-key block encryption device in the first example.

The common-key block encryption device in the first example comprises plain text input means (101), first Feistel-type hash means (102), unit block encryption means (103), pseudorandom number generation means (104), addition means (105), second Feistel-type hash means (106), and cipher text output means (107).

The common-key block encryption device in this example can be implemented by a CPU, a memory, and a disk. Each means of the common-key block encryption device is implemented when the CPU executes a program, stored in the disk, for executing the means.

The following describes the means configuring the common-key block encryption device.

<Plain Text Input Means 101>

The plain text input means (101) receives a plain text to be encrypted. For example, it is implemented by a character input device such as a keyboard.

<First Feistel-Type Hash Means 102>

The first Feistel-type hash means (102) divides a plain text, received from the plain text input means (101), into a PA block and a PB block, compresses the divided PB block by the hash function, and adds the compressed PB block and the PA block. After that, the first Feistel-type hash means (102) concatenates the sum of the PB block, compressed by the hash function, and the PA block, which is not compressed by the hash function, with the PB block in the form before being compressed by the hash function and outputs the concatenated result.

For example, when a plain text entered from the plain text input means (101) is represented by two blocks (PA, PB) and the hash function is represented by H(x), the first Feistel-type hash means (102) compresses a part (PB) of the plain text, entered from the plain text input means (101), by the hash function H(x), concatenates the sum (PA+H(PB)) of the compressed part of the plain text H(PB) and the other part of the plain text (PA), entered from the plain text input means (101), with the plain text (PB) in the form before being compressed by the hash function H(x), and externally outputs the concatenated result. As a result, the first Feistel-type hash means (102) externally outputs an output text (PA+H(PB),PB). PA+H(PB) output from the first Feistel-type hash means (102) is called a unit block intermediate text. The symbol + represents addition and, if both PA and PB are elements in the powers-of-2 space, the symbol + is equivalent to the exclusive logical OR processing. Note that the hash function H must be ‘almost universal XOR’. This means that, for two different inputs to the hash function H, the sum of the output of the hash function H corresponding to each of the inputs is distributed almost uniformly. Such a hash function H, generally called a universal hash function, can be implemented by using Multimodular Hash Function disclosed in Non-Patent Document 4.

<Unit Block Encryption Means (103)>

The unit block encryption means (103) generates a unit block intermediate cipher text that is the cipher text of the unit block intermediate text received from the first Feistel-type hash means (102). The unit block intermediate cipher text can be generated by AES (Advanced Encryption Standard)-based block encryption, for example, block encryption disclosed in Non-Patent Document 5, that is secure against the chosen plain text attack/cipher text attack.

<Pseudorandom Number Generation Means (104)>

The pseudorandom number generation means (104) generates an intermediate random number based on the unit block intermediate cipher text output from the unit block encryption means (103).

The pseudorandom number generation means (104) in the first example is required to be secure against the chosen plain text attack. That is, when an attacker arbitrarily selects a unit block intermediate cipher text and generates an intermediate random number based on the selected unit block intermediate cipher text, it is required that the attacker finds it difficult to distinguish between the generated random numbers and true random numbers. The pseudorandom number generation means (104) in the first example, which uses the method disclosed in Patent Document 1 given above, combines encryption processing that is secure against the chosen plain text attack with encryption processing that is secure against the known plain text attack to generate an intermediate random number. If encryption is secure against the chosen plain text/cipher text attack, the encryption is secure against the chosen plain text attack. Therefore, the block encryption used by the unit block encryption means (103) can be applied to the method, disclosed in Patent Document 1 described above, as the encryption parts that are secure against the chosen plain text attack.

<Addition Means 105>

The addition means (105) adds the intermediate random number, generated by the pseudorandom number generation means (104), and the part (PB block) of the plain text output from the first Feistel-type hash means (102) and outputs the addition value produced by the addition processing.

<Second Feistel-Type Hash Means (106)>

The second Feistel-type hash means (106) supplies the addition value, output by the addition means (105), to the hash function to calculate the hash value, adds the calculated hash value and the unit block intermediate cipher text output by the unit block encryption means (103), concatenates the addition result with the addition value output by the addition means (105), and outputs the output result. The second Feistel-type hash means (106) can be implemented in the same way as the first Feistel-type hash means (102).

<Cipher Text Output Means (107)>

The cipher text output means (107) outputs the output result, received from the second Feistel-type hash means (106), as a cipher text. This cipher text output means (107) can be implemented by a computer display or a printer.

(Description of Operation of Common-Key Block Encryption Device)

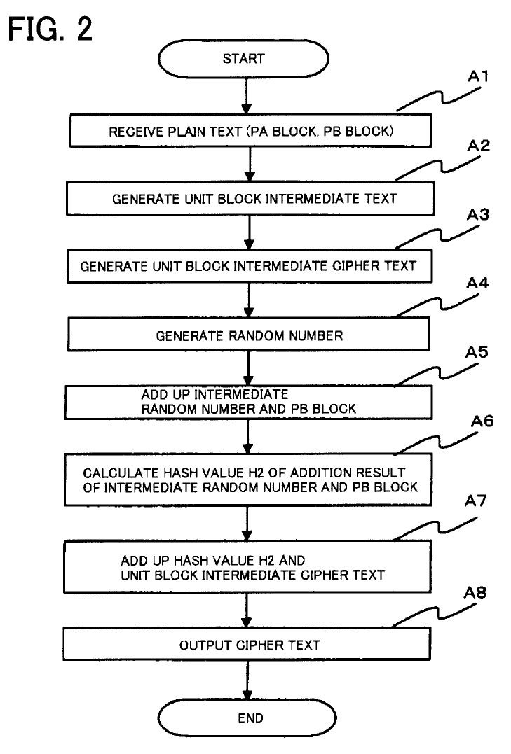

Next, with reference to FIG. 2, the following describes the processing operation of the common-key block encryption device in the first example shown in FIG. 1.

First, the plain text input means (101) inputs a plain text (PA block, PB block) to be encrypted to the first Feistel-type hash means (102) (step A1).

The first Feistel-type hash means (102) divides the plain text (PA block, PB block), received from the plain text input means (101), into the PA block and the PB block, uses the hash function to compress the divided PB block, and adds the compressed PB block (H(PB)) and the PA block (PA) to create a unit block intermediate text (PA+H(PB)) (step A2). The first Feistel-type hash means (102) concatenates the unit block intermediate text with the PB block in the form before being compressed by the hash function and outputs the concatenated result. The first Feistel-type hash means (102) outputs the unit block intermediate text to the unit block encryption means (103) and, at the same time, outputs the PB block in the form before being compressed by the hash function to the addition means (105).

Next, the unit block encryption means (103) encrypts the unit block intermediate text, received from the first Feistel-type hash means (102), to generate a unit block intermediate cipher text and outputs the generated unit block intermediate cipher text to the pseudorandom number generation means (104) and the second Feistel-type hash means (106) (step A3).

The pseudorandom number generation means (104) generates an intermediate random number based on the unit block intermediate cipher text received from the unit block encryption means (103) and outputs the generated intermediate random number to the addition means (105) (step A4).

The addition means (105) adds the intermediate random number, received from the pseudorandom number generation means (104), and the PB block received from the first Feistel-type hash means (106) and outputs the addition value, produced by the addition processing, to the second Feistel-type hash means (102) (step A5).

The second Feistel-type hash means (106) passes the addition value, produced by adding up the intermediate random number received from the addition means (105) and the PB block, to the hash function to calculate the hash value H2 of the addition value (step A6).

Next, the second Feistel-type hash means (106) adds the hash value H2 calculated as described above and the unit block intermediate cipher text received from the unit block encryption means (103), generates a cipher text (step A7), and outputs the generated cipher text to the cipher text output means (107). The cipher text output means (107) outputs the cipher text received from the second Feistel-type hash means (106) (step A8).

As described above, the common-key block encryption device in the first example receives a plain text to be encrypted, divides the received plain text into the PA block and the PB block, compresses the divided PB block by the hash function, and adds the compressed PB block (H(PB)) and the PA block (PA) to generate a unit block intermediate text (PA+H(PB)). The device encrypts the unit block intermediate text (PA+H(PB)), generated by the above processing, to generate a unit block intermediate cipher text and then generates an intermediate random number based on the generated unit block intermediate cipher text. Next, the device adds the generated intermediate random number and the PB block to calculate the addition result. After that, the device compresses the calculated addition result by the has function, adds the compressed addition result and the unit block intermediate cipher text to calculate the second addition result, and outputs a cipher text based on the calculated second addition result and the addition result.

In this way, the common-key block encryption device in this example combines the encryption parts that are secure against the chosen plain text/cipher text attack with the encryption parts that are secure against the known plain text attack to perform high-speed, secure block encryption for a large block size. The common-key block encryption device in this example calls the encryption parts, which are secure against the chosen plain text/cipher text attack, two times for encrypting one block regardless of the block size, thus making the throughput of the encryption of a large block size almost equal to the throughput of the encryption parts that are secure against the known plain text attack. Because the known plain text attack belongs to a class of attacks weaker than the chosen plain text/cipher text attack, the encryption parts that are secure against the known plain text attack usually operate faster than the encryption parts that are secure against the chosen plain text/cipher text attack. Therefore, it is possible to perform block encryption that is faster than the encryption operation mode that uses only the encryption parts that are secure against the chosen plain text/cipher text attack.

Although the first Feistel-type hash means (102) divides a plain text, received from the plain text input means (101), into the PA block and PB block in the example described above, it is also possible that the plain text input means (101) divides the plain text into the PA block and the PB block and outputs the divided PA block and the PB block to the first Feistel-type hash means (102).

### Second Example

Next, a second example will be described.

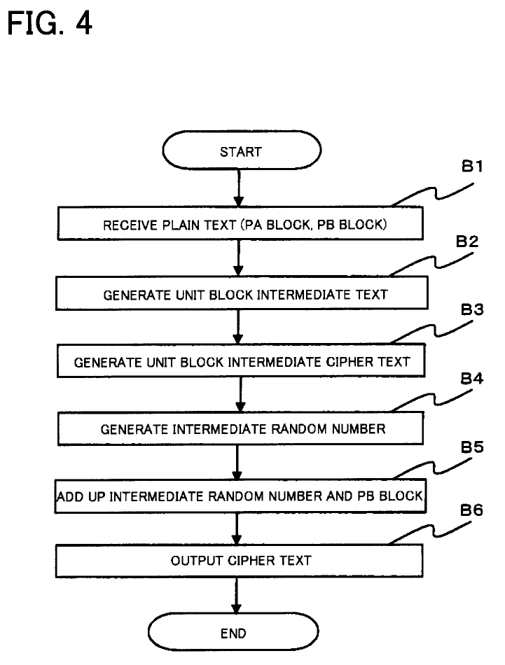

A common-key block encryption device in the second example comprises plain text input means (201) that receives a plain text to be encrypted; first Feistel-type hash means (202) that divides the plain text into a PA block and a PB block, compresses the divided PB block by the hash function, adds the compressed PB block and the PA block to generate a unit block intermediate text, and outputs the generated unit block intermediate text and the PB block; unit block encryption means (203) that encrypts the unit block intermediate text to generate a unit block intermediate cipher text; pseudorandom number generation means (204) that generates an intermediate random number based on the unit block intermediate cipher text; addition means (205) that adds the intermediate random number and the PB block and outputs an addition result; and cipher text output means (206) that concatenates the addition result with the unit block intermediate cipher text and outputs the concatenated text as a cipher text. With reference to FIG. 3 and FIG. 4, the following describes the common-key block encryption device in the second example.

First, with reference to FIG. 3, the following describes the configuration of the common-key block encryption device in the second example. FIG. 3 is a block diagram showing the configuration of the common-key block encryption device in the second example.

The common-key block encryption device in the second example comprises the plain text input means (201), first Feistel-type hash means (202), unit block encryption means (203), pseudorandom number generation means (204), addition means (205), and cipher text output means (206).

As in the first example, the common-key block encryption device in the second example can be implemented by a CPU, a memory, and a disk. Each means of the common-key block encryption device is implemented when the CPU executes a program, stored in the disk, for executing the means.

Next, the following describes the means constituting the common-key block encryption device in the second example. The plain text input means (201), first Feistel-type hash means (202), unit block encryption means (203), and addition means (205) constituting the common-key block encryption device in the second example are configured by the functions similar to those of the means (101, 102, 103, and 105) that constitute the common-key block encryption device in the first example. Note that the unit block encryption means (203) is only required to be secure against the chosen plain text attack.

<Pseudorandom Number Generation Means 204>

The pseudorandom number generation means (204) in the second example generates an intermediate random number based on a unit block intermediate cipher text. The pseudorandom number generation means (204) in the second example is required to be secure against the known plain text attack.

That is, when an intermediate random number is generated based on a random unit block intermediate cipher text, the pseudorandom number generation means (204) in the second example is only required to generate random numbers that are difficult to be distinguished from true random numbers but is not required to ensure security (security against chosen plain text attack) under circumstances where an attacker can arbitrarily select a unit block intermediate cipher text.

<Cipher Text Output Means 206>

The cipher text output means (206) concatenates the value output from the addition means (205) with the unit block intermediate cipher text output from the unit block encryption means (203) and outputs the concatenated result as a cipher text.

(Description of Operation of Common-Key Block Encryption Device)

Next, with reference to FIG. 4, the following describes the processing operation of the common-key block encryption device in the second example.

First, the plain text input means (201) inputs a plain text (PA block, PB block) to be encrypted to the first Feistel-type hash means (202) (step B1).

Next, the first Feistel-type hash means (202) divides the plain text (PA block, PB block), received from the plain text input means (201), into a PA block and a PB block, compresses the divided PB block by the hash function, adds the compressed PB block (H(PB)) and the PA block (PA) to create a unit block intermediate text (PA+H(PB)), and outputs the created unit block intermediate text to the unit block encryption means (203) (step B2). The first Feistel-type hash means (202) also outputs the plain text (PB block), entered from the plain text input means (201), to the addition means (205).

Next, the unit block encryption means (203) encrypts the unit block intermediate text, received from the first Feistel-type hash means (202), to create a unit block intermediate cipher text and outputs the created unit block intermediate cipher text (step B3).

Next, the pseudorandom number generation means (204) creates an intermediate random number based on the unit block intermediate cipher text received from the unit block encryption means (203) and outputs the created intermediate random number to the addition means (205) (step B4).

Next, the addition means (205) adds the intermediate random number, received from the pseudorandom number generation means (204), and the PB block in the plain text form received from the first Feistel-type hash means (202) and outputs the addition result to the cipher text output means (206) (step B5).

The cipher text output means (206) concatenates the unit block intermediate cipher text received from the unit block encryption means (203) with the addition result received from the addition means (205) and outputs the concatenated result as a cipher text (step B6).

As described above, the block encryption device in the second example receives a plain text to be encrypted, divides the received plain text into the PA block and the PB block, compresses the divided PB block by the hash function, and adds the compressed PB block (H(PB)) and the PA block (PA) to generate a unit block intermediate text (PA+H(PB)). The device encrypts the unit block intermediate text (PA+H(PB)), generated by the above processing, to generate a unit block intermediate cipher text and then generates an intermediate random number based on the generated unit block intermediate cipher text. Next, the device adds the generated intermediate random number and the PB block to calculate the addition result. After that, the device concatenates the calculated addition result with the unit block intermediate cipher text and outputs the concatenated result as a cipher text.

In this way, the common-key block encryption device in this example combines the encryption parts that are secure against the chosen plain text attack with the encryption parts that are secure against the known plain text attack to perform high-speed, secure block encryption for a large block size. The common-key block encryption device in this example calls the encryption parts, which are secure against the chosen plain text attack, once for encrypting one block regardless of the block size, thus making the throughput of the encryption of a large block size almost equal to the throughput of the encryption parts that are secure against the known plain text attack. Because the known plain text attack belongs to a class of attacks weaker than the chosen plain text attack, the encryption parts that are secure against the known plain text attack usually operate faster than the encryption parts that are secure against the chosen plain text attack. Therefore, it is possible to perform block encryption that is faster than the encryption operation mode that uses only the encryption parts that are secure against the chosen plain text attack.

Although the first Feistel-type hash means (202) divides a plain text, received from the plain text input means (201), into the PA block and PB block in the example described above, it is also possible that the plain text input means (201) divides the plain text into the PA block and the PB block and outputs the divided PA block and the PB block to the first Feistel-type hash means (202).

### Third Example

Next, a third example will be described.

A common-key block encryption device in the third example is characterized in that the unit block encryption means (103) of the common-key block encryption device in the first example converts a unit block intermediate text to a unit block intermediate cipher text using block encryption and in that the pseudorandom number generation means (104) concatenates the multiple-block cipher texts to generate an intermediate random number by entering the unit block intermediate cipher text into the ordered tree mode implemented by the block encryption and a simplified block encryption created by simplifying the block encryption. The following describes the common-key block encryption device in the third example. The common-key block encryption device in the third example comprises the same means as those of the common-key block encryption device in the first example shown in FIG. 1.

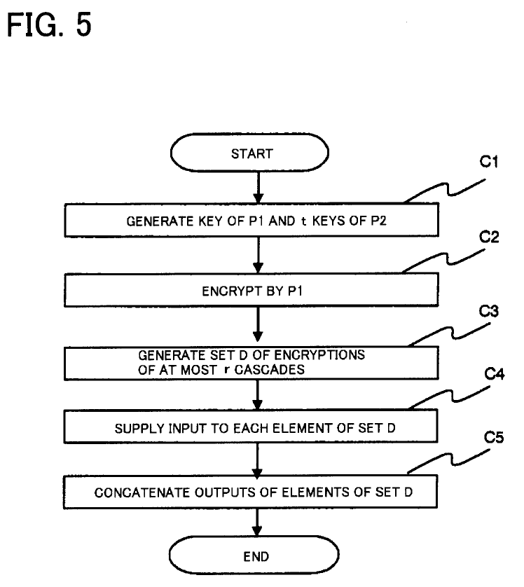

Next, with reference to FIG. 5, the following describes the processing operation of the pseudorandom number generation means (104) of the common-key block encryption device in the third example. FIG. 5 is a flowchart showing the processing operation of the pseudorandom number generation means (104) in this example.

Let P1 represent block encryption, and let P2 represent simplified block encryption that is a simplified version obtained by deleting one or more stages from, or simplifying a part of the internal functions of, the block encryption P1. For example, the common-key block encryption device in this example can be implemented by using AES, disclosed in Non-Patent Document 5, for the block encryption P1 and using the AES 7-stage version for the simplified block encryption P2.

The pseudorandom number generation means (104) in the third example first generates the key of the block encryption P1 and t (t is a positive integer) keys of the simplified block encryption (step C1). Next, the pseudorandom number generation means (104) encrypts the unit block intermediate cipher text, received from the unit block encryption means (103), by the block encryption P1 (step C2).

Next, for the unit block intermediate cipher text encrypted in step C2 described above, the pseudorandom number generation means (104) further creates the set D of all cascades for at most r(r is a positive integer equal to or smaller than t) times of the simplified block encryption P2 using different t keys (step C3), enters the unit block intermediate cipher text, encrypted in step C2, into each element of the created set D, and calculates the output result (step C4).

At this time, for two cascades out of the elements of the set D that start with the same contents, the output result of one cascade is calculated using the output result of the other cascade. Finally, the output results of those elements are concatenated (step C5). The mode in which the block encryption P1 and the simplified block encryption P2 are used is called an ordered tree mode.

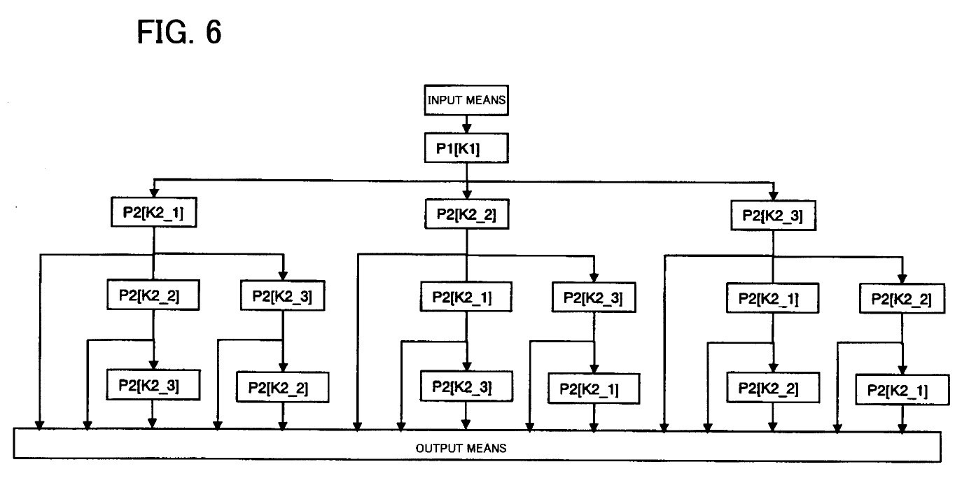

FIG. 6 is a block diagram of the pseudorandom number generation means (104) when t=3 and r=3. When r=1, the method is similar to that of (Expression 1) described above. The key length is the linear order of n in the method shown by (Expression 1) (that is, when r=1) where n is the number of output blocks in the ordered tree mode, while the key length is the log order of n when r=t. Although an increase in r increases the length of output results that can be generated for the number of keys, the security of encryption is decreased in inverse proportion to the increase.

In this way, the unit block encryption means (103) of the common-key block encryption device in the third example converts a unit block intermediate plain text to a unit block intermediate cipher text using block encryption, and the pseudorandom number generation means (104) generates an intermediate random number by concatenating the multiple-block cipher texts obtained by entering the unit block intermediate cipher text into the ordered tree mode, implemented by the block encryption and the simplified block encryption obtained by simplifying the block encryption. Because the key length can be reduced to the log order of the number of output blocks of the ordered tree mode, it is possible to reduce the key scheduling time and to reduce the overhead time before the cipher text is output.

That is, a block encryption key is usually generated by master-key-based key scheduling. This means that, if this key is short, the master-key-based key scheduling time for generating this key can also be reduced.

### Fourth Example

Next, a fourth example will be described.

A common-key block encryption device in the fourth example is characterized in that the pseudorandom number generation means (104) of the common-key block encryption device in the third example generates an intermediate random number based on the PRT mode described in (Expression 1′) given above, the ERT mode, or the combination mode of the ordered tree mode, PRT mode, and ERT mode.

The ERT mode is a mode created by expanding the PRT mode, described in (Expression 1′) given above, as shown by (Expression 1″) given below.

( . . . (G_{—}[1,1]ΔG_{—}[2,3])ΔG_{—}[3,9] . . . G_[d,3̂(d−1)])(Y) (Expression 1″)

where, Y is a unit block intermediate cipher text and the symbol A is an operator that combines FΔG(x)=(F(x),G(x,F(x))) for two functions F and G.

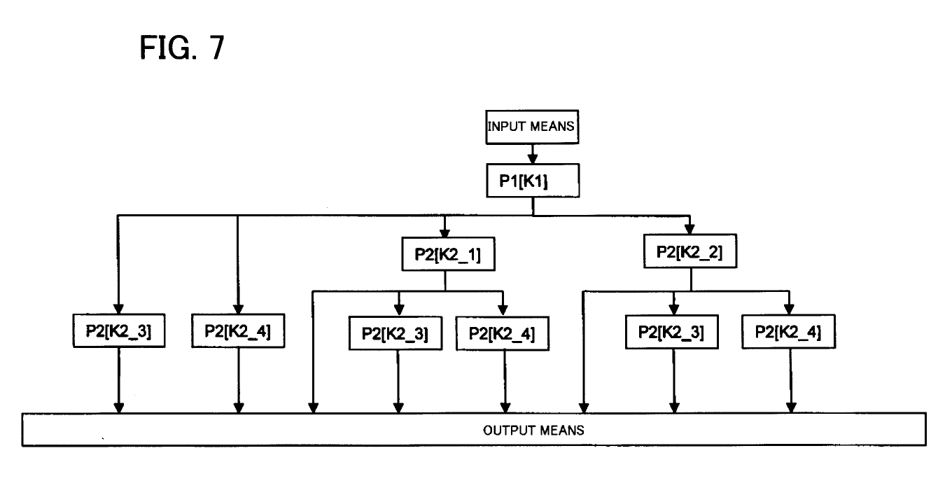

The input width of G is the sum of the output width of F and the width of the whole input x. In (Expression 1″) given above, the mode is called an extended PRT (Extended PRT, ERT) mode when Y is a cipher text generated by P1. The ERT mode is characterized in that the key length is shorter than that in the PRT mode. More specifically, when the expansion rate is high, the ERT mode requires a key length that is about 60% of a key length in the PRT mode. FIG. 7 shows an example of the ERT mode when four keys of P2 are used.

The pseudorandom number generation means (104) can also use a combination of any of PRT, ERT, and the ordered tree mode. For example, when G_[i] is an ordered tree mode using two keys for i=1, 2, . . . , the mode is one-block input/four-block output, which is combined with the ERT mode as shown by (Expression 2″) given below.

( . . . (G_{—[1,1}]ΔG_{—[2,5}])ΔG_{—[3,25}] . . . G_[d,5̂(d−1)](Y) (Expression 2″)

This combination mode requires about 30% of the key length of that in the PRT mode when the expansion rate is high. Although the ordered tree mode is the best mode better than the PRT mode and ERT mode in the key length, it has an installation disadvantage because the program size increases as the expansion rate is increased. However, combining the modes in this way makes it possible to create a mode that is more efficient in the key length than in the basic ERT mode shown by (Expression 1″) while preventing the program from becoming extremely complex. Various other combination patterns are also possible with the required key length and the installation feasibility varying according to each pattern.

### Fifth Example

Next, a fifth example will be described.

A common-key block encryption device in the fifth example is characterized in that the pseudorandom number generation means (104) of the common-key block encryption device in the first example generates an intermediate random number based on the modified counter mode, shown in (Expression 2) given above, of the single-block encrypt ion.

In this way, the pseudorandom number generation means (104) can generate an intermediate random number based on the modified counter mode, shown in (Expression 2) given above, of the single-block encryption to simplify the key.

### Sixth Example

Next, a sixth example will be described.

A common-key block encryption device in the sixth example is characterized in that the pseudorandom number generation means (104) of the common-key block encryption device in the first example generates an intermediate random number based on the modified OFB mode, shown in (Expression 3) given above, of the single-block encrypt ion.

In this way, the pseudorandom number generation means (104) can generate an intermediate random number based on the modified OFB mode, shown in (Expression 3) given above, of the single-block encryption to simplify the key.

### Seventh Example

Next, a seventh example will be described.

A common-key block encryption device in the seventh example is characterized in that the unit block encryption means (203) of the common-key block encryption device in the second example converts a unit block intermediate plain text to a unit block intermediate cipher text using block encryption and in that the pseudorandom number generation means (204) generates an intermediate random number by concatenating multiple cipher texts obtained by entering the unit block intermediate cipher text into the mode in which the first encryption processing of the ordered tree mode, implemented by block encryption and simplified block encryption created by simplifying the block encryption, is omitted. The following describes the common-key block encryption device in the seventh example.

The common-key block encryption device in the seventh example is characterized in that the pseudorandom number generation means (204) of the common-key block encryption device in the second example enters the unit block intermediate cipher text into the mode, in which the encryption by the block encryption P1 (step C2 in FIG. 5) is omitted from the ordered tree mode shown in FIG. 5, to generate an intermediate random number.

In this way, in the common-key block encryption device in the seventh example, the unit block encryption means (203) converts a unit block intermediate plain text to a unit block intermediate cipher text using block encryption and the pseudorandom number generation means (204) generates an intermediate random number by concatenating multiple cipher texts obtained by entering the unit block intermediate cipher text into the mode in which the first encryption processing of the ordered tree mode, implemented by block encryption and simplified block encryption created by simplifying the block encryption, is omitted. This configuration can reduce the key length to the log order of the number of output blocks in the ordered tree mode, reduce the key scheduling time and, therefore, shorten the overhead time before the cipher text is output.

That is, a block encryption key is usually generated by master-key-based key scheduling. This means that, if this key is short, the master-key-based key scheduling time for generating this key can also be reduced.

### Eighth Example

Next, an eighth example will be described.

A common-key block encryption device in the eighth example is characterized in that the pseudorandom number generation means (204) of the common-key block encryption device in the seventh example generates an intermediate random number by concatenating multiple cipher texts obtained by entering the unit block intermediate cipher text into a mode in which the first encryption processing by the block encryption P1 is omitted from the PRT mode described in (Expression 1′) given above that is implemented by block encryption and simplified block encryption created by simplifying the block encryption, from the ERT mode described in (Expression 1″) given above, or from the combination mode of the ordered tree mode, PRT mode, and ERT mode such as the one shown in (Expression 2″).

### Ninth Example

Next, a ninth example will be described.

A common-key block encryption device in the ninth example is characterized in that the pseudorandom number generation means (204) of the common-key block encryption device in the second example generates an intermediate random number by using a mode in which only the first encryption performed for an input in the modified counter mode of (Expression 2) that uses single block encryption is omitted.

In this way, the pseudorandom number generation means (204) generates an intermediate random number by using a mode in which only the first encryption performed for the input in the modified counter mode shown in (Expression 2) that uses single block encryption is omitted and, thereby, simplifies the key.

### Tenth Example

Next, a tenth example will be described.

A common-key block encryption device in the tenth example is characterized in that the pseudorandom number generation means (204) of the common-key block encryption device in the second example generates an intermediate random number by using a mode in which only the first encryption performed for the input in the modified OFB mode shown in (Expression 3) that uses single block encryption is omitted.

In this way, the pseudorandom number generation means (204) generates an intermediate random number by using a mode in which only the first encryption performed for the input in the modified OFB mode shown in (Expression 3) that uses single block encryption is omitted and, thereby, simplifies the key.

### Eleventh Example

Next, an eleventh example will be described.

A common-key block encryption device in the eleventh example is characterized in that the pseudorandom number generation means (104, 204) of the common-key block encryption device in the first and second examples uses stream encryption, in which an additional value called an initial vector is received as input for generating a key stream, to output a key stream, generated with a unit block intermediate cipher text as its input, as an intermediate random number.

The stream encryption like this can be implemented, for example, by the stream encryption SEAL disclosed in Non-Patent Document 6. This stream encryption can also be implemented by encrypting a unit block intermediate cipher text using block encryption and then entering the encrypted result into stream encryption in which an initial vector is accepted as its input.

In this way, the unit block encryption means (103, 203) of the common-key block encryption device in the first and second examples converts a unit block intermediate plain text to a unit block intermediate cipher text using block encryption. After that, the pseudorandom number generation means (104, 204) generates a key stream as an intermediate random number to simplify the key, wherein the key stream is obtained by entering the unit block intermediate cipher text, which is an initial vector, into stream encryption that accepts the initial vector as an additional input.

While the examples described above are preferred examples of the present invention, it is to be understood that the present invention is not limited to the examples given above but that various changes and modifications may be made without departing from the spirit of the present invention. For example, the processing operation of the common-key block encryption device in the above examples can be executed by computer programs, and the programs can be recorded in a recording medium, such as an optical recording medium, a magnetic recording medium, a magneto-optical recording medium, and a semiconductor, from which the programs are read into an information processing device for executing the processing operation in the information processing device. It is also possible that the programs are read from an external device, connected to a predetermined network, into the information processing device for execution in the information processing device.

### INDUSTRIAL APPLICABILITY

The common-key block encryption device, the common-key block encryption method, and the common-key block encryption program according to the present invention are applicable to a system where encrypted communication is performed between two users, to a system that reliably delivers contents such as movies or music, and to file encryption for reliably managing data on a computer server. This application is based upon and claims the benefit of the priority from Japanese patent application No. 2004-366363, filed on Dec. 17, 2004 and No. 2005-200188 filed on Jul. 8, 2005, the disclosure of which is incorporated herein in its entirety by reference. Also in this application, the disclosures of the above mentioned patent documents and non-patent documents are incorporated herein in its entirety by reference.

Though the present invention has been described in accordance with the foregoing examples, the invention is not limited to this example and it goes without saying that the invention covers various modifications and changes that would be obvious to those skilled in the art within the scope of the claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

1. A common-key block encryption device comprising:
first Feistel-type hash means that divides a plain text to be encrypted into a first block and a second block, compresses the divided first block by a hash function, adds the compressed first block and the second block to generate a unit block intermediate text, and outputs the generated unit block intermediate text and the first block;
unit block encryption means that encrypts the unit block intermediate text to generate a unit block intermediate cipher text;
pseudorandom number generation means that generates an intermediate random number based on the unit block intermediate cipher text;
addition means that adds the intermediate random number and the first block and outputs an addition result;
second Feistel-type hash means that compresses the addition result by a hash function, adds the compressed addition result and the unit block intermediate cipher text to generate a second addition result, and outputs an output result that is a combination of the generated second addition result and the addition result; and
cipher text output means that outputs the output result as a cipher text.

2. A common-key block encryption device comprising:
first Feistel-type hash means that divides a plain text to be encrypted into a first block and a second block, compresses the divided first block by a hash function, adds the compressed first block and the second block to generate a unit block intermediate text, and outputs the generated unit block intermediate text and the first block;
unit block encryption means that encrypts the unit block intermediate text to generate a unit block intermediate cipher text;
pseudorandom number generation means that generates an intermediate random number based on the unit block intermediate cipher text;
addition means that adds the intermediate random number and the first block and outputs an addition result; and
cipher text output means that concatenates the addition result with the unit block intermediate cipher text and outputs the concatenated result as a cipher text.

3. The common-key block encryption device as defined by claim 1, wherein said unit block encryption means encrypts the unit block intermediate text using block encryption to generate the unit block intermediate cipher text; and
said pseudorandom number generation means generates the intermediate random number by concatenating multiple-block cipher texts, said multiple-block cipher texts being obtained by entering the unit block intermediate cipher text into an ordered tree mode implemented by the block encryption and a simplified block encryption obtained by simplifying the block encryption.

4. The common-key block encryption device as defined by claim 1, wherein said unit block encryption means encrypts the unit block intermediate text using block encryption to generate the unit block intermediate cipher text; and
said pseudorandom number generation means generates the intermediate random number by concatenating multiple-block cipher texts, said multiple-block cipher texts being obtained by entering the unit block intermediate cipher text into a PRT mode that is implemented by the block encryption and simplified block encryption created by simplifying the block encryption, into an ERT mode, or into a combination mode of an ordered tree mode, the PRT mode, and the ERT mode.

5. The common-key block encryption device as defined by claim 1, wherein said unit block encryption means encrypts the unit block intermediate text using block encryption to generate the unit block intermediate cipher text; and
said pseudorandom number generation means generates the intermediate random number by concatenating multiple-block cipher texts, said multiple-block cipher texts being obtained by entering the unit block intermediate cipher text into a modified counter mode that uses the block encryption.

6. The common-key block encryption device as defined by claim 1, wherein said unit block encryption means encrypts the unit block intermediate text using block encryption to generate the unit block intermediate cipher text; and
said pseudorandom number generation means generates the intermediate random number by concatenating multiple-block cipher texts, said multiple-block cipher texts being obtained by entering the unit block intermediate cipher text into a modified OFB mode that uses the block encryption.

7. The common-key block encryption device as defined by claim 2, wherein said unit block encryption means encrypts the unit block intermediate text using block encryption to generate the unit block intermediate cipher text; and
said pseudorandom number generation means generates the intermediate random number by concatenating a plurality of cipher texts, said plurality of cipher texts being obtained by entering the unit block intermediate cipher text into a mode in which first encryption processing of an ordered tree mode, implemented by the block encryption and a simplified block encryption created by simplifying the block encryption, is omitted.

8. The common-key block encryption device as defined by claim 2, wherein said unit block encryption means encrypts the unit block intermediate text using block encryption to generate the unit block intermediate cipher text; and
said pseudorandom number generation means generates the intermediate random number by concatenating a plurality of cipher texts, said plurality of cipher texts being obtained by entering the unit block intermediate cipher text into a mode in which first encryption processing is omitted from a PRT mode that is implemented by the block encryption and simplified block encryption created by simplifying the block encryption, from an ERT mode, or from a combination mode of an ordered tree mode, the PRT mode, and the ERT mode.

9. The common-key block encryption device as defined by claim 2, wherein said unit block encryption means encrypts the unit block intermediate text using block encryption to generate the unit block intermediate cipher text; and
said pseudorandom number generation means generates the intermediate random number by concatenating multiple-block cipher texts obtained by entering the unit block intermediate cipher text into a mode in which first encryption processing of a modified counter mode that uses the block encryption is omitted.

10. The common-key block encryption device as defined by claim 2, wherein said unit block encryption means encrypts the unit block intermediate text using block encryption to generate the unit block intermediate cipher text; and
said pseudorandom number generation means generates the intermediate random number by concatenating multiple-block cipher texts obtained by entering the unit block intermediate cipher text into a mode in which first encryption processing of a modified OFB mode that uses the block encryption is omitted.

11. The common-key block encryption device as defined by claim 1, wherein said unit block encryption means encrypts the unit block intermediate text using block encryption to generate the unit block intermediate cipher text; and
said pseudorandom number generation means generates the intermediate random number by entering, as an initial vector, the unit block intermediate cipher text into stream encryption that accepts the initial vector as an additional input.

12. A common-key block encryption method performed by an information processing device comprising:
a first Feistel-type hash step that divides a plain text to be encrypted into a first block and a second block, compresses the divided first block by a hash function, adds the compressed first block and the second block to generate a unit block intermediate text, and outputs the generated unit block intermediate text and the first block;
a unit block encryption step that encrypts the unit block intermediate text to generate a unit block intermediate cipher text;
a pseudorandom number generation step that generates an intermediate random number based on the unit block intermediate cipher text;
an addition step that adds the intermediate random number and the first block and outputs an addition result;
a second Feistel-type hash step that compresses the addition result by a hash function, adds the compressed addition result and the unit block intermediate cipher text to generate a second addition result, and outputs the generated second addition result and the addition result; and
a cipher text output step that outputs a cipher text based on the second addition result and the addition result.

13. A common-key block encryption method performed by an information processing device comprising:
first Feistel-type hash step that divides a plain text to be encrypted into a first block and a second block, compresses the divided first block by a hash function, adds the compressed first block and the second block to generate a unit block intermediate text, and outputs the generated unit block intermediate text and the first block;
unit block encryption step that encrypts the unit block intermediate text to generate a unit block intermediate cipher text;
pseudorandom number generation step that generates an intermediate random number based on the unit block intermediate cipher text;
addition step that adds the intermediate random number and the first block and outputs an addition result; and
cipher text output step that concatenates the addition result with the unit block intermediate cipher text and outputs the concatenated result as a cipher text.

14. The common-key block encryption method as defined by claim 12, wherein said unit block encryption step encrypts the unit block intermediate text using block encryption to generate the unit block intermediate cipher text; and
said pseudorandom number generation step generates the intermediate random number by concatenating multiple-block cipher texts, said multiple-block cipher texts being obtained by entering the unit block intermediate cipher text into an ordered tree mode implemented by the block encryption and a simplified block encryption obtained by simplifying the block encryption.

15. The common-key block encryption method as defined by claim 12, wherein said unit block encryption step encrypts the unit block intermediate text using block encryption to generate the unit block intermediate cipher text; and
said pseudorandom number generation step generates the intermediate random number by concatenating multiple-block cipher texts, said multiple-block cipher texts being obtained by entering the unit block intermediate cipher text into a PRT mode that is implemented by the block encryption and simplified block encryption created by simplifying the block encryption, into an ERT mode, or into a combination mode of an ordered tree mode, the PRT mode, and the ERT mode.

16. The common-key block encryption method as defined by claim 12, wherein said unit block encryption step encrypts the unit block intermediate text using block encryption to generate the unit block intermediate cipher text; and
said pseudorandom number generation step generates the intermediate random number by concatenating multiple-block cipher texts, said multiple-block cipher texts being obtained by entering the unit block intermediate cipher text into a modified counter mode that uses the block encryption.

17. The common-key block encryption method as defined by claim 12, wherein said unit block encryption step encrypts the unit block intermediate text using block encryption to generate the unit block intermediate cipher text; and
said pseudorandom number generation step generates the intermediate random number by concatenating multiple-block cipher texts, said multiple-block cipher texts being obtained by entering the unit block intermediate cipher text into a modified OFB mode that uses the block encryption.

18. The common-key block encryption method as defined by claim 13, wherein said unit block encryption step encrypts the unit block intermediate text using block encryption to generate the unit block intermediate cipher text; and
said pseudorandom number generation step generates the intermediate random number by concatenating a plurality of cipher texts, said plurality of cipher texts being obtained by entering the unit block intermediate cipher text into a mode in which first encryption processing of an ordered tree mode, implemented by the block encryption and a simplified block encryption created by simplifying the block encryption, is omitted.

19. The common-key block encryption method as defined by claim 13, wherein said unit block encryption step encrypts the unit block intermediate text using block encryption to generate the unit block intermediate cipher text; and
said pseudorandom number generation step generates the intermediate random number by concatenating a plurality of cipher texts, said plurality of cipher texts being obtained by entering the unit block intermediate cipher text into a mode in which first encryption processing is omitted from a PRT mode that is implemented by the block encryption and simplified block encryption created by simplifying the block encryption, from an ERT mode, or from a combination mode of an ordered tree mode, the PRT mode, and the ERT mode.

20. The common-key block encryption method as defined by claim 13, wherein said unit block encryption step encrypts the unit block intermediate text using block encryption to generate the unit block intermediate cipher text; and
said pseudorandom number generation step generates the intermediate random number by concatenating multiple-block cipher texts obtained by entering the unit block intermediate cipher text into a mode in which first encryption processing of a modified counter mode that uses the block encryption is omitted.

21. The common-key block encryption method as defined by claim 13, wherein said unit block encryption step encrypts the unit block intermediate text using block encryption to generate the unit block intermediate cipher text; and
said pseudorandom number generation step generates the intermediate random number by concatenating multiple-block cipher texts obtained by entering the unit block intermediate cipher text into a mode in which first encryption processing of a modified OFB mode that uses the block encryption is omitted.

22. The common-key block encryption method as defined by claim 12, wherein said unit block encryption step encrypts the unit block intermediate text using block encryption to generate the unit block intermediate cipher text; and
said pseudorandom number generation step generates the intermediate random number by entering, as an initial vector, the unit block intermediate cipher text into stream encryption that accepts the initial vector as an additional input.

23. A common-key block encryption program causing an information processing device to execute:
a first Feistel-type hash processing that divides a plain text to be encrypted into a first block and a second block, compresses the divided first block by a hash function, adds the compressed first block and the second block to generate a unit block intermediate text, and outputs the generated unit block intermediate text and the first block;
a unit block encryption processing that encrypts the unit block intermediate text to generate a unit block intermediate cipher text;
a pseudorandom number generation processing that generates an intermediate random number based on the unit block intermediate cipher text;
an addition processing that adds the intermediate random number and the first block and outputs an addition result;
a second Feistel-type hash processing that compresses the addition result by a hash function, adds the compressed addition result and the unit block intermediate cipher text to generate a second addition result, and outputs the generated second addition result and the addition result; and
a cipher text output processing that outputs a cipher text based on the second addition result and the addition result.

24. A common-key block encryption program causing an information processing device to execute:
a first Feistel-type hash processing that divides a plain text to be encrypted into a first block and a second block, compresses the divided first block by a hash function, adds the compressed first block and the second block to generate a unit block intermediate text, and outputs the generated unit block intermediate text and the first block;
a unit block encryption processing that encrypts the unit block intermediate text to generate a unit block intermediate cipher text;
a pseudorandom number generation processing that generates an intermediate random number based on the unit block intermediate cipher text;
an addition processing that adds the intermediate random number and the first block and outputs an addition result; and
a cipher text output processing that concatenates the addition result with the unit block intermediate cipher text and outputs the concatenated result as a cipher text.

25. The common-key block encryption program as defined by claim 23, wherein said unit block encryption processing encrypts the unit block intermediate text using block encryption to generate the unit block intermediate cipher text; and
said pseudorandom number generation processing generates the intermediate random number by concatenating multiple-block cipher texts, said multiple-block cipher texts being obtained by entering the unit block intermediate cipher text into an ordered tree mode implemented by the block encryption and a simplified block encryption obtained by simplifying the block encryption.

26. The common-key block encryption program as defined by claim 23, wherein said unit block encryption processing encrypts the unit block intermediate text using block encryption to generate the unit block intermediate cipher text; and
said pseudorandom number generation processing generates the intermediate random number by concatenating multiple-block cipher texts, said multiple-block cipher texts being obtained by entering the unit block intermediate cipher text into a PRT mode that is implemented by the block encryption and simplified block encryption created by simplifying the block encryption, into an ERT mode, into an ordered tree mode, or into a combination mode of the ordered tree mode, the PRT mode, and the ERT mode.

27. The common-key block encryption program as defined by claim 23, wherein said unit block encryption processing encrypts the unit block intermediate text using block encryption to generate the unit block intermediate cipher text; and
said pseudorandom number generation processing generates the intermediate random number by concatenating multiple-block cipher texts, said multiple-block cipher texts being obtained by entering the unit block intermediate cipher text into a modified counter mode that uses the block encryption.

28. The common-key block encryption program as defined by claim 23, wherein said unit block encryption processing encrypts the unit block intermediate text using block encryption to generate the unit block intermediate cipher text; and
said pseudorandom number generation processing generates the intermediate random number by concatenating multiple-block cipher texts, said multiple-block cipher texts being obtained by entering the unit block intermediate cipher text into a modified OFB mode that uses the block encryption.

29. The common-key block encryption program as defined by claim 24, wherein said unit block encryption processing encrypts the unit block intermediate text using block encryption to generate the unit block intermediate cipher text; and
said pseudorandom number generation processing generates the intermediate random number by concatenating a plurality of cipher texts, said plurality of cipher texts being obtained by entering the unit block intermediate cipher text into a mode in which first encryption processing of an ordered tree mode, implemented by the block encryption and a simplified block encryption created by simplifying the block encryption, is omitted.

30. The common-key block encryption program as defined by claim 24, wherein said unit block encryption processing encrypts the unit block intermediate text using block encryption to generate the unit block intermediate cipher text; and
said pseudorandom number generation processing generates the intermediate random number by concatenating a plurality of cipher texts, said plurality of cipher texts being obtained by entering the unit block intermediate cipher text into a mode in which first encryption processing is omitted from a PRT mode that is implemented by the block encryption and simplified block encryption created by simplifying the block encryption, from an ERT mode, or from a combination mode of an ordered tree mode, the PRT mode, and the ERT mode.

31. The common-key block encryption program as defined by claim 24, wherein said unit block encryption processing encrypts the unit block intermediate text using block encryption to generate the unit block intermediate cipher text; and
said pseudorandom number generation processing generates the intermediate random number by concatenating multiple-block cipher texts obtained by entering the unit block intermediate cipher text into a mode in which first encryption processing of a modified counter mode that uses the block encryption is omitted.

32. The common-key block encryption program as defined by claim 24, wherein said unit block encryption processing encrypts the unit block intermediate text using block encryption to generate the unit block intermediate cipher text; and
said pseudorandom number generation processing generates the intermediate random number by concatenating multiple-block cipher texts obtained by entering the unit block intermediate cipher text into a mode in which first encryption processing of a modified OFB mode that uses the block encryption is omitted.

33. The common-key block encryption program as defined by claim 23, wherein said unit block encryption processing encrypts the unit block intermediate text using block encryption to generate the unit block intermediate cipher text; and
said pseudorandom number generation processing generates the intermediate random number by entering, as an initial vector, the unit block intermediate cipher text into stream encryption that accepts the initial vector as an additional input.

34. A common-key block encryption device comprising:
first Feistel-type hash means that, regarding first and second blocks produced either by receiving a plain text from plain text input means and dividing the received plain text into two or by dividing the plain text into two by said plain text input means, comprises:
means for supplying the first block to a hash function to calculate a first hash value; and
means for adding the first hash value and the second block and outputting an addition result as a unit block intermediate text;
unit block encryption means that receives and encrypts the unit block intermediate text output from said first Feistel-type hash means and outputs the encrypted unit block intermediate text as a unit block intermediate cipher text;
pseudorandom number generation means that receives the unit block intermediate cipher text, output from the unit block encryption means, generates an intermediate random number based on the unit block intermediate cipher text, and outputs the generated intermediate random number;
addition means that receives the intermediate random number, output from said pseudorandom number generation means, and the first block in a form before being input to the hash function in said first Feistel-type hash means, adds the intermediate random number and the first block, and outputs an addition result;
second Feistel-type hash means that comprises means for receiving the addition result of the intermediate random number and the first block, which is output from said addition means, and supplying the addition result to a hash function to calculate a second hash value, means for receiving the second hash value and the unit block intermediate cipher text that is output from said unit block encryption means, adding them up, and outputting an addition result, and means for adding up the addition result of the second hash value and the unit block intermediate cipher text and the addition result of the intermediate random number and the first block, which is output from said addition means, and outputting an addition result as a cipher text; and
cipher text output means that outputs the cipher text output from said second Feistel-type hash means.

35. A common-key block encryption device comprising:
first Feistel-type hash means that, regarding first and second blocks produced either by receiving a plain text from plain text input means and dividing the received plain text into two or by dividing the plain text into two by said plain text input means, comprises: means for supplying the first block to a hash function to calculate a first hash value; and means for adding the first hash value and the second block and outputting an addition result as a unit block intermediate text;
unit block encryption means that receives and encrypts the unit block intermediate text output from said first Feistel-type hash means and outputs the encrypted unit block intermediate text as a unit block intermediate cipher text;
pseudorandom number generation means that receives the unit block intermediate cipher text, output from the unit block encryption means, generates an intermediate random number based on the unit block intermediate cipher text, and outputs the generated intermediate random number;
addition means that receives the intermediate random number, output from said pseudorandom number generation means, and the first block in a form before being input to the hash function in said first Feistel-type hash means, adds the intermediate random number and the first block, and outputs an addition result; and
cipher text output means that receives the addition result of the intermediate random number and the first block, output from said addition means, and the unit block intermediate cipher text output from said unit block encryption means, concatenates the addition result with the unit block intermediate cipher text, and outputs a concatenated result as a cipher text.
